(19) United States
(12) Patent Application Publication
(10) Pub. No.: US 2015/0069810 A1
(43) Pub. Date: Mar. 12, 2015

(54) PRESSURE-DISTRIBUTING FOAM AND VEHICLE SEAT ASSEMBLY HAVING PRESSURE-DISTRIBUTING FOAM

(71) Applicant: Johnson Controls Technology Company, Holland, MI (US)

(72) Inventors: Ryoko Yamasaki, Ypsilanti, MI (US); Eugene Peiffer, Plymouth, MI (US)

(73) Assignee: Johnson Controls Technology Company, Holland, MI (US)

(21) Appl. No.: 14/020,707

(22) Filed: Sep. 6, 2013

(51) Int. Cl. C08G 18/32; B29D 99/00; B29C 44/02; B60N 2/68; B60N 2/70

(52) U.S. Cl. CPC C08G 18/3206; B60N 2/68; B60N 2/70; B29C 44/02; B29D 99/0092; B29K 2071/02
USPC 297/391; 297/452.18; 297/411.2; 297/452.48; 264/46.4; 521/174; 521/176

(57) ABSTRACT

A pressure-distributing foam structure for use in a seat application may he produced from a foam mixture comprising an ethylene oxide capped diol in a range of about 37 to about 96% weight. The foam structure may have a hardness at 25% deflection that varies within +/−150% in a temperature range of −20° C. to 50° C. The foam structure has a hysteresis loss that varies within +/−40% in the temperature range of −20° C. to 50° C. The pressure-distributing foam structure may be used in a seat component, such as a seat back, a seat cushion, and/or a head rest. A method of making the pressure-distributing foam structure may comprise mixing the ethylene oxide capped diol with at least one of a copolymer polyol and a base polyol.

### BACKGROUND

The present disclosure relates to a pressure-distributing foam, a seat assembly for a vehicle comprising pressure-distributing foam, and a method of making a vehicle seat assembly comprising pressure-distributing foam.

Viscoelastic foam (a.k.a. memory foam) with its slow recovery characteristics has been marketed as a material that provides excellent static comfort, and it became popular in bedding industry. However, some characteristics of viscoelastic foam are unsuitable for an automotive seating application. For example, properties, such as, for example, hardness of viscoelastic foam, vary greatly depending on the temperature and humidity of the vehicle. For example, viscoelastic foam may be extremely hard in freezing temperatures and may be extremely soft in a high humidity environment. Such variances in the properties of the viscoelastic foam is an issue for an automotive application because vehicle seats are exposed to wide ranges of temperature and humidity during use.

Also, a typical viscoelastic foam is not desirable for the craftsmanship of an automotive seat because its signature slow recovery will make the cover look loose for a period of time after the seat occupant leaves the seat. Additionally, the commercially available viscoelastic foams are typically made as a slab foam, so the pre-made foam has to be processed further (e.g. cut, glue, mold in) to incorporate in automotive seating, which increases material and process costs.

### SUMMARY

According to one embodiment of the present invention, a pressure-distributing foam structure for use in a seat application may be produced from a foam mixture comprising an ethylene oxide capped diol in a range of about 37 to about 96% weight. The foam structure may have a hardness at 25% deflection that varies within +/−150% in a temperature range of −20° C. to 50° C., and a hysteresis loss that may vary within +/−40% in the temperature range of −20° C. to 50° C.

According to one embodiment of the present invention, a vehicle seat may comprise a seat component comprising a frame structure, and a pressure-distributing foam structure. The foam structure may abut the frame structure. The foam structure may be produced from a foam mixture comprising an ethylene oxide capped diol in a range of about 37 to about 96% weight. The foam structure may have a hardness at 25% deflection that varies within +/−150% in a temperature range of −20° C. to 50° C., and a hysteresis loss that may vary within +/−40% in the temperature range of −20° C. to 50° C. The seat component may he one of a seat cushion, a seat back, a head rest, an arm rest, or a combination thereof.

According to another embodiment of the present invention, a method of making a pressure-distributing foam structure may comprise: mixing an ethylene oxide capped diol in a range of about 37 to about 96% weight and at least one of a copolymer polyol in a range of less than 60% weight, and a base polyol in a range of less than about 60% weight to form a foam mixture; disposing the foam mixture into a mold; and curing the foam mixture to form the foam structure. The foam structure may have a hardness at 25% deflection that varies within +/−150% in a temperature range of −20° C. to 50° C. and a hysteresis loss that may vary within +/−40% in the temperature range of −20° C. to 50° C. Also, an isocyanate with a range of index between, for example, 50-120, may optionally be included in the foam mixture.

It is to be understood that both the foregoing general description and the following detailed description are exemplary and explanatory only, and are not restrictive of the invention as claimed.

### BRIEF DESCRIPTION OF THE DRAWINGS

The features, aspects and advantages of the present invention will become apparent from the following description, appended claims, and the accompanying exemplary embodiments shown in the drawings, which are briefly described below.

FIG. 1 is a perspective view of a motor vehicle according to an embodiment of the present invention.

FIG. 2 is a perspective view of a seat assembly for use within a motor vehicle, such as the motor vehicle of FIG. 1.

FIG. 3 is a schematic cross-sectional view of the body of the seat assembly of FIG. 2.

FIG. 4 is a table of various examples of the pressure-distributing polyurethane foam according to embodiments of the present invention.

FIG. 5 shows the hardness at 25% deflection of the pressure-distributing polyurethane foam over various combinations of temperature and humidity.

FIG. 6 shows the hysteresis loss of the pressure-distributing polyurethane foam over various combinations of temperature and humidity.

FIG. 7 is a block diagram of the method steps used to make the pressure-distributing foam structure according to an exemplary embodiment.

### DETAILED DESCRIPTION

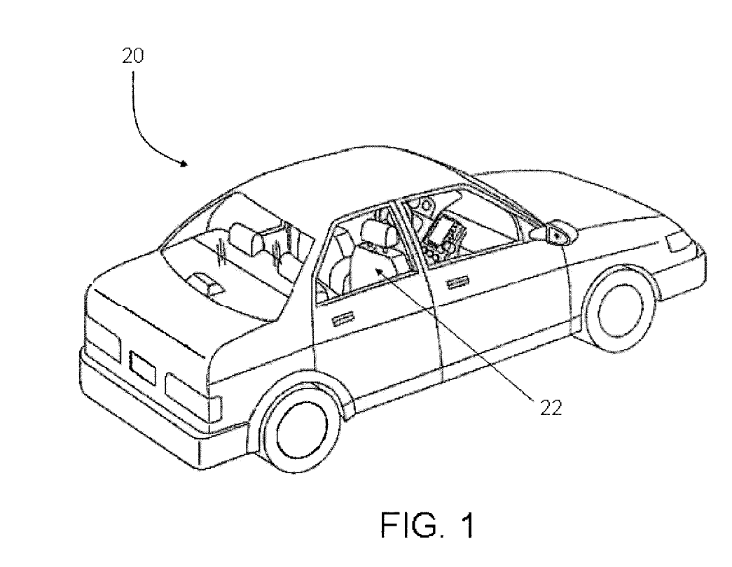

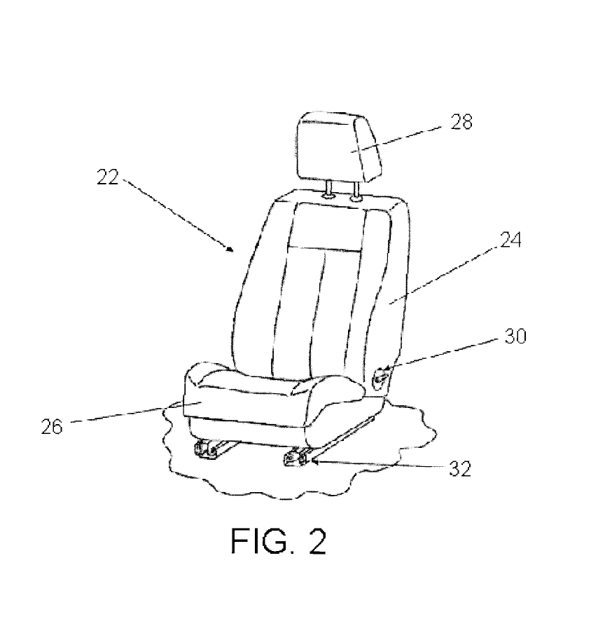

FIG. 1 shows a vehicle 20 according to one embodiment of the present invention. The vehicle 20 can include one or more seat assemblies 22 provided for occupant(s) of the vehicle. FIG. 2 shows an embodiment of a seat assembly 22 used in a motor vehicle, such as the motor vehicle 20 of FIG. 1. While the vehicle 20 of FIG. 1 is a four door sedan. it should be understood that the seat assembly may be used in mini-vans, sport utility vehicles, trucks, buses, airplanes, trains, boats, or any type of other vehicle.

As shown in FIG. 2, the seat assembly 22 can include a seat back 24; a seat cushion 26; a head rest 28; a recliner mechanism 30 to provide rotatable adjustability of the seat back 24 with respect to the seat cushion 26; and a track assembly 32 to provide translational adjustability of the seat assembly 22 in the front-and-rear directions of the motor vehicle 20 for comfort or utility.

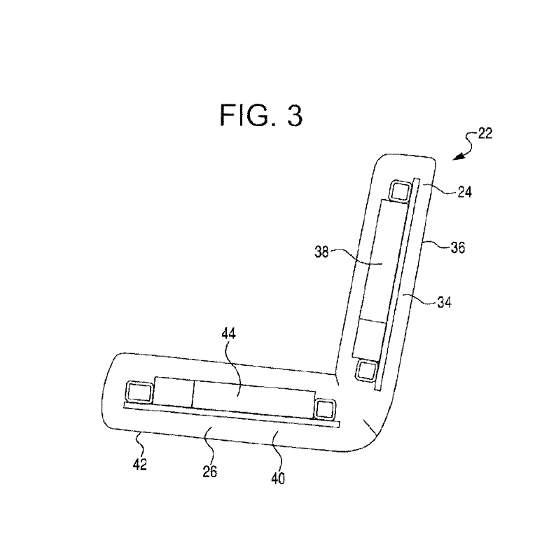

FIG. 3 is a schematic cross-sectional view of the body of the seat assembly 22 of FIG. 2. The seat back 24 can include, for example, a foam structure 34, a trim cover 36, and a frame structure 38. The seat cushion 26 can include, for example, a foam structure 40, a trim cover 42, and a frame structure 44. The seat assembly 22 in FIGS. 2 and 3 is a one-occupant seat typically used in the front row of a vehicle, but the seat assembly may be any seat assembly that resides in a vehicle (for example, a second or third row bench).

The foam structure that may be used in the seat back 24, the seat cushion 26, and/or the head rest 28 of the seat assembly 22 may comprise a pressure-distributing polyurethane foam.

According to one embodiment of the present invention, the pressure-distributing polyurethane foam may be formed from a foam mixture comprising ethylene oxide (EO) capped diol in the range of about 37 to about 96% weight, preferably in the range of about 50 to about 95% weight, more preferably in the range of about 65 to about 95% weight. For example, the amount of EO capped diol in % weight may be 37, 38, 39, 50, 75, 85, 96 or any 0.1 increment therebetween. According to one embodiment, the EO capped diol may be an EO-capped di-functional polyether polyol, for example, PLURACOL® 628 from BASF; and/or PREMINOL® 5005 or PREMINOL® 5001F from Asahi Glass, but the EO capped diol is not limited to these examples. Furthermore, the EO capped dint may comprise one or more components from the above list and their like.

In addition to the EO capped diol, the pressure-distributing polyurethane foam may be formed from a foam mixture comprising one or more of the following components: copolymer polyol (CPP), a base polyol, a polymer additive, water, a cross-linker, a surfactant, a cell opener, a gelling additive, and a blowing additive. The amounts of each of these components are provided as follows.

The amount of copolymer polyol (CPP) may be in the range of about 0 to about 60% weight, preferably in the range of about 0 to about 30% weight, more preferably in the range of about 5 to about 25% weight. For example, the amount of CPP in % weight may be 0, 1, 2, 3, 4, 5, 10, 20, 30, 59, or any 0.1 increment therebetween. The average nominal functionality (Fn) of the CPP may be greater than or equal to 2.0. For example, the CPP may have an Fn in the range of about 2.0 to 6.0, such as 2.0, 2.1, 2.2, 3.0, 4.0, 5.0, 6.0 or any 0.1 increment therebetween. A suitable CPP may be multi-functional such as, for example, PLURACOL® 1528 or PLURACOL® 1365 from BASF; HYPERLITE® E-850 from Bayer; SPECFLEX® NC701 from Dow Chemical; ULTIFLOW® FM-5704 or SANNIX® KC-900 from Sanyo Chemical; KE880S from KPX; and/or TPOP-05/45 from SINOPEC, but the CPP is not limited to these examples. Furthermore, the CCP may comprise one or more components from the above list and their like.

The amount of base polyol may be in the range of about 0 to about 60% weight, preferably in the range of about 0 to about 30% weight, more preferably in the range of about 0 to about 10% weight. For example, the amount of base polyol in % weight may be 0, 1, 2, 3, 4, 5, 10, 20, 30, 59, or any 0.1 increment therebetween. Also, the average nominal functionality (Fn) of the base polyol may be greater than or equal to 2.5. For example, the CPP may have an Fn in the range of about 2.5 to 6.0, such as 2.5, 2.6, 2.7, 3.0, 4.0, 5.0, 6.0 or any 0.1 increment therebetween. A suitable base polyol may he, for example, a multi-functional polyether polyol, such as, for example, PLURACOL® 1603 from BASF; HYPERLITE® E-833 or MULTRANOL® 3901 from Bayer; SPECFLEX® NC630, VORANOL® 360, VORANOL® WK3140 from Dow Chemical; PREMINOL® 7003 or PREMINOL® 7012 from Asahi Glass; EP-901P or EP-902 from Mitsui Chemical; YUKOL® 3531 or YUKOL® 3328 from SKC; and/or TEP-330N from SINOPEC, but the base polyol is not limited to these examples. Furthermore, the base polyol may comprise one or more components from the above list and their like.

The amount of a polymer additive may be in the range of about 0 to about 30% weight, preferably in the range of about 0 to about 15% weight, more preferably in the range of about 0 to about 10% weight. For example, the amount of polymer additive in % weight may be 0, 1, 2, 3, 4, 5, 10, 20, 30 or any 0.1 increment therebetween. A monol may be used as the polymer additive, such as, a monol selected from at least one of benzyl alcohol, 2,2-dimethyl-1,3-dioxolane-4-methano-1, and alcohol ethoxylate. Examples of suitable polymers may be, but are not limited to, ELASTOPAN® 5291T Gel or PLURACOL Balance® 160 from BASF and/or UCON® TPEG990 from Dow Chemical. Furthermore, the polymer additive may be other monol or non-monol substances, such as one or more of a UV stabilizer(s), bio material (such as, for example, caster oil or soy polyol), colorant, gel, or any polymer typically used in the foam making process. Furthermore, the polymer additive may comprise one or more components from the above lists and their like.

The amount of water may vary depending on the desired density. For example, the amount of water may be in the range of about 0 to about 7% weight. For example, the amount of water in % weight may be 0, 1, 2, 3, 4, 5, 7, or any 0.1 increment therebetween.

The amount of cross-linker may be in the range of about 0 to about 5% weight, preferably in the range of about 0 to about 2.5% weight, more preferably in the range of about 0 to about 1% weight. For example, the amount of cross-linker in % weight may be 0, 1, 2, 3, 4, 5, or any 0.1 increment therebetween. The cross-linker may be an amine-based cross-linker, such as, for example, one or more of triethanolamine, diethanolamine, and glycerine, but the cross-linker is not limited to these examples. Furthermore, the cross-linker may comprise one or more components from the above list and their like.

The amount of surfactant may be in the range of about 0 to about 4% weight, preferably in the range of about 0 to about 3% weight, more preferably in the range of about 0 to about 2% weight. For example, the amount of surfactant in % weight may he 0, 0.01, 1, 3, 4, or any 0.01 increment therebetween. Any suitable surfactant that is used in polyurethane foam production may be used, such as, for example, TEGOSTAB® B8724LF2, TEGOSTAB® B8737LF2, or TEGOSTAB® B8742LF2 from Evonik; and/or NIX® L-3640, NIAX L-3620, or NIAX® L-3556 from Momentive, but the surfactant is not limited to these examples. Furthermore, the surfactant may comprise one or more components from the above list and their like.

The amount of cell opener may be in the range of about 0 to about 20% weight, preferably in the range of about 0 to about 10% weight, more preferably in the range of about 0 to about 5% weight. For example, the amount of cell opener in % weight may be 0, 1, 2, 3, 5, 20, or any 0.01 increment therebetween. The cell opener may have at least one of a paraffinic, cyclic, and aromatic hydrocarbon chain. According to one embodiment, the cell opener may he mineral oil, however other cell openers may be used, such as, for example, silicone oils, corn oil, palm oil, linseed oil, soybean oil and defoamers based on particulates, such as silica. Other suitable cell openers may be used as well, such as, for example, MULTRANOL® 9199 from Bayer; VORANOL® 4053 or VORANOL® CP1421 from Dow Chemical; and/or Y-8331 from SKC, but the cell opener is not limited to these examples. Furthermore, the cell opener may comprise one or more components from the above list and their like.

During the formation of the foam structure, a blowing catalyst (or balanced catalyst) and a gelling catalyst may be used. The ratio of gelling catalyst to blowing catalyst may range from 1 to 8. For example, the ratio may be 1, 2, 3, 5, 8, or any 0.01 increment therebetween. Furthermore, the amount of blowing catalyst may be in the range of about 0 to about 5% weight. preferably in the range of about 0 to about 1% weight, more preferably in the range of about 0 to about 0.5% weight. Also, the amount of gelling catalyst may be in the range of about 0 to about 5% weight, preferably in the range of about 0 to about 2% weight, more preferably in the range of about 0 to about 1% weight

For the blowing catalyst, any blowing catalyst that is used in polyurethane foam production may be used, such as, for example, DABCO® BL-11, DABCO® NE 1070, POLYCAT® 77 from Air Products; TEGOAMIN® BDE from Evonik; NIAX® A-1, NIAX® A-440, or EF-700 from Momentive;and/or JEFFCAT® ZF-22 or JEFFCAT® ZF-10 from Huntsman. Furthermore, the blowing catalyst may comprise one or more components from the above list and their like. According to one example, if water is not used (that is, 0%), different components in the blowing may be used to compensate, such as, for example, CO₂ or a non-water blowing component.

For the gelling catalyst, any gelling catalyst that is used in polyurethane foam production may be used, such as, for example, DABCO® 33-LV from Air Products; TEGOAMIN® 33 from Evonik; NIAX® A-33 or NIAX® A-300, EF-600 from Momentive; JEFFCAT® TD-33A or JEFFCAT® LE-210 from Huntsman; and/or TEDA-L33 from TOSOH. Furthermore, the gelling catalyst may comprise one or more components from the above list and their like.

Furthermore, the foam mixture for the production of the foam structure may comprise, for example, an isocyanate, such as, for example, methylene diphenyl diisocyanate (MDI), a toluene diisocyanate (TDI), or any blend and/or prepolymer using MDI or TDI. Examples include, but are not limited to, MONDUR® 445, MONDUR® 1488, or MONDUR® TD80 from Bayer; and/or RUBINATE® 7304 from Huntsman. The isocyanate may have a range of index between, for example, about 50 and about 120.

### EXAMPLES

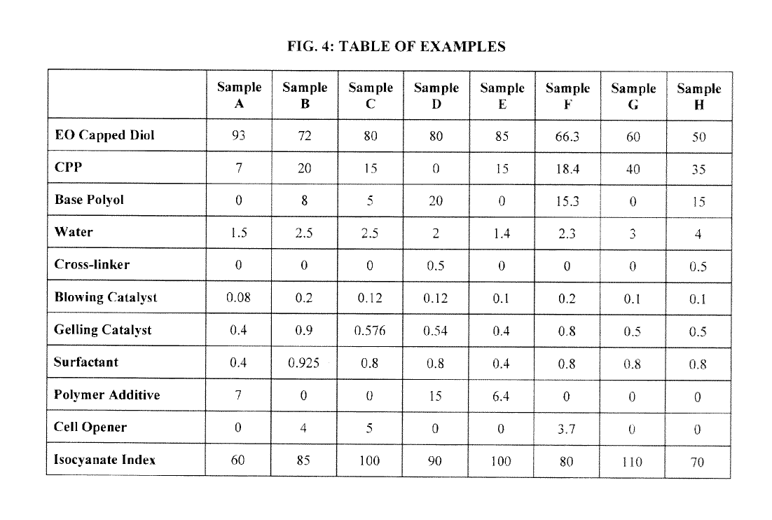

FIG. 4 is a table of examples of the foam mixture used to make the pressure-distributing polyurethane foam structure according to various embodiments of the present invention. Each of the components forming the composition is listed in % weight, unless otherwise indicated.

For sample A, a MDI-based process was used with RUBINATE® 7304 as the isocyanate. The gel-blowing ratio is 5.0. The EO capped diol is PREMINOL® 5005, the CPP is ULTIFLOW® FM-5704, the blowing catalyst is NIAX® A-1, the gelling catalyst is DABCO® 33-LV, the surfactant is TEGOSTAB® B8742 LF2, and the polymer additive is UCON® TPEG990.

For sample B, a MDI-based process was used with RUBINATE® 7304 as the isocyanate. The gel-blowing ratio is 4.5. The EO capped diol is PLURACOL® 628, the CPP is HYPERLITE® E-850 (10% weight) and PLURACOL® 1365 (10% weight), the base polyol is VORANOL® 360, the blowing catalyst is NIAX® A-1, the gelling catalyst is DABCO® 33-LV, the surfactant is DABCO® DC5164 (0.22% weight) and DABCO® DC5179 (0.705% weight), and the cell opener is VORANOL® 4053.

For sample C, a MDI-based process was used with RUBINATE® 7304 as the isocyanate. The gel-blowing ratio is 4.8. The EO capped diol is PLURACOL® 628, the CPP is HYPERLITE® E-850 (5% weight) and PLURACOL® 1365 (10% weight), the base polyol is VORANOL® 360, the blowing catalyst is NIAX® A-1, the gelling catalyst is DABCO® 33-LV, the surfactant is DABCO® DC5164 (0.4% weight) and DABCO® DC5179 (0.4% weight), and the cell opener is VORANOL® 4053.

For sample D, a TDI-based process was used with MONDUR® 445 as the isocyanate. The gel-blowing ratio is 4.5. The EO capped diol is PLURACOL® 628, the base polyol is VORANOL® 360, the blowing catalyst is NIAX® A-1, the gelling catalyst is DABCO® 33-LV, the surfactant is DABCO® DC5164 (0.4% weight) and DABCO® DC5179 (0.4% weight)and the polymer additive is ELASTOPAN® 5291T.

For sample E, a MDI-based process was used with RUBINATE® 7304 as the isocyanate. The gel-blowing ratio is 5.0. The EO capped diol is PREMINOL® 5005, the CPP is ULTIFLOW® FM-5704, the blowing catalyst is NIAX® A-1, the gelling catalyst is DABCO® 33-LV, the surfactant is TEGOSTAB® B8742 LF2, and the polymer additive is UCON® TPEG990.

For sample F, a MDI-based process was used with RUBINATE® 7304 as the isocyanate. The gel-blowing ratio is 4.5. The EO capped diol is PLURACOL® 628, the CPP is HYPERLITE® E-850 (9.2% weight) and PLURACOL® 1365 (9.2% weight), the base polyol is VORANOL® 360, the blowing catalyst is NIAX® A-1, the gelling catalyst is DABCO® 33-LV, the surfactant is DABCO® DC5164 (0.2% weight) and DABCO® DC5179 (0.6% weight), and the cell opener is VORANOL® 4053.

For sample G, a MDI-based process was used with RUBINATE® 7304 as the isocyanate. The gel-blowing ratio is 4.8. The EO capped diol is PLURACOL® 628, the CPP is a combination of HYPERLITE® E-850 and PLURACOL® 1365, the blowing catalyst is NIAX® A-1, the gelling catalyst is DABCO® 33-LV, and the surfactant is DABCO® DC5164 (0.4% weight) and DABCO® DC5179 (0.4% weight).

For sample H, a TDI-based process was used with MONDUR® 445 as the isocyanate. The gel-blowing ratio is 4.5. The EO capped diol is PLURACOL® 628, the CPP is a combination of HYPERL1TE® E-850 and PLURACOL® 1365, the base polyol is VORANOL® 360, the blowing catalyst is NIAX® A-1, the gelling catalyst is DABCO® 33-LV, and the surfactant is DABCO® DC5164 (0.4% weight) and DABCO® DC5179 (0.4% weight).

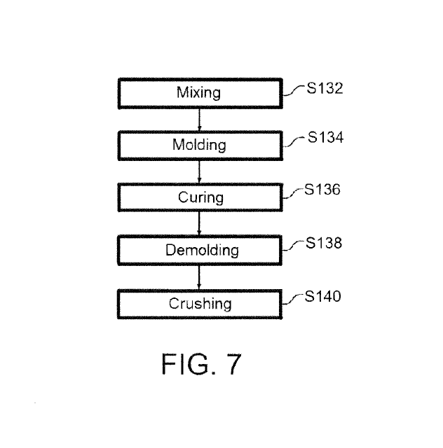

FIG. 7 is a block diagram of the method steps used to make the pressure-distributing foam structure according to one embodiment of the present invention. The manufacture of the pressure-distributing foam structure may be performed by mixing the components for making the foam in a mix head in step S132. The components that are mixed in the mix head comprise one or more of the EO capped diol, CPP, the base polyol, the polymer additive, water, the cross-linker, the surfactant, the cell opener, the gelling additive, the blowing additive, and the isocyanate in any of the respective amounts indicated above for each component in any combination.

In step S134, the foam mixture is poured into a foam mold tool. The water and blowing catalyst may be used to do the blowing of the foam components, thus affecting the desired foam density. In step S136, the foam mixture is cured into a foam structure. In step S138, the foam structure is demolded from the molding tool.

Optionally, the foam structure may be crushed in step S140. The foam structure may be crushed a pre-selected number of times during a pre-selected time period after demold.

The resulting foam structure may be generally in the shape of a block having particular dimensions or may have a particular contoured shape usable for a particular application, such as a vehicle seat cushion, a vehicle seat back, a head rest, or any subcomponent thereof such as, for example, a lumbar cushion or a holster cushion.

The method may further include, at a particular time during the curing of the foamed mixture, a tool pressure release to release the pressure from the mold tool to vent off the gasses of the foaming process and to lower the temperature of the foamed structure.

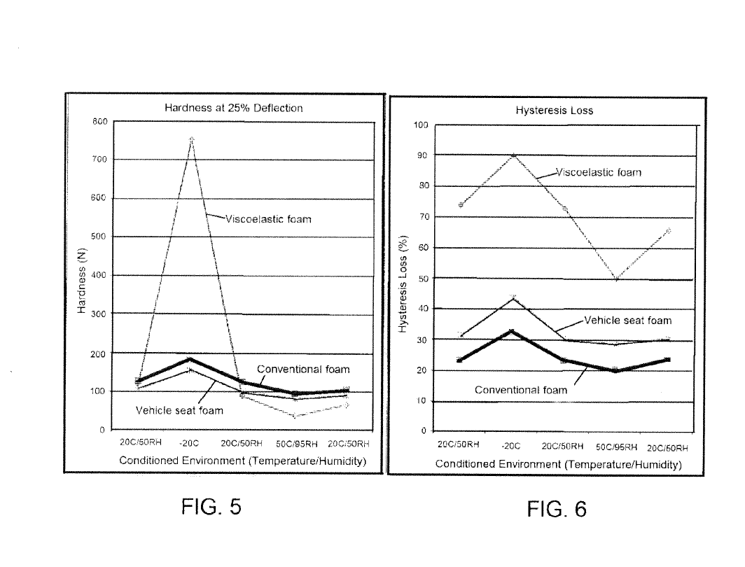

With the use of pressure-distributing polyurethane foam, a vehicle seat assembly may have the foam structure in the seat back 24, the seat cushion 26, the head rest 28, or a combination thereof with a property of slow to semi-slow recovery with smaller changes in the foam properties over a wide range of temperature and humidity than typically viscoelastic (memory) foam. For example, the operational range of the foam can be between −20° C. to 95° C. Furthermore, the operational relative humidity of the foam structure is 0-100%. FIGS. 5 and 6 show the hardness at 25% deflection and the hysteresis loss over various combinations of temperature and humidity. As can be seen the variation of hardness and hysteresis loss of the vehicle seat foam according to an embodiment of the present invention is smaller than that for the conventional viscoelastic foam, but has slow or semi-slow recovery characteristic of viscoelastic foam. According to one embodiment of the present invention, the foam structure can have a hardness at 25% deflection that varies within +/−150% in a temperature range of −20° C. to 50° C., preferably within +/−100% in the temperature range of −20° C. to 50° C. Other examples include foam structures that can have a hardness at 25% deflection that varies within +/−1%, 50%, 100%, 150%, or any integer therebetween in a temperature range of −20° C. to 50° C. For example, as can be seen in FIG. 5, the foam structure can have a hardness at 25% deflection that varies within +/−100 N in a temperature range of −20° C. to 50° C. Preferably, though not required, the foam structure may have a hardness at 25% deflection that varies within +/−50 N in the temperature range of −20° C. to 50° C. Also, the foam structure can have a hysteresis loss that varies within +/−40% in a temperature range of −20° C. to 50° C. Preferably, though not required, the foam structure has a hysteresis loss that varies within +/−20% in a temperature range of −20° C. to 50° C. Other examples include foam structures that have a hysteresis loss that varies within +/−1%, 5%, 15%, 20%, 39% or any integer therebetween in a temperature range of −20° C. to 50° C.

Of course, the rate of recovery, as well as other properties (e.g. hardness), of the vehicle seat assembly according to the present invention can be varied, so that it can be tailored for desired static and/or dynamic comfort, and to ensure a good craftsmanship.

Also, the use of pressure-distributing polyurethane foam enables the manufacturing into a desired shape by using the same process as a conventional molded foam.

Furthermore, other technologies (such as, for example, PU Gel, Bio Gel, Dual Horizontal Hardness foam, and VT foam) can be used with the pressure-distributing foam technology to achieve improved static and/or dynamic comfort.

As utilized herein, the terms “approximately,” “about,” “substantially”, and similar terms are intended to have a meaning in harmony with the common and accepted usage by those of ordinary skill in the art to which the subject matter of this disclosure pertains. For example, the terms “approximately,” “about,” “substantially”, and similar terms may mean about +/−10% of the value or term they modify, preferably +/−5% of the value or term they modify. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples). In addition, any one of the features provided in any one of the embodiments disclosed herein may be incorporated into any one of the other embodiments disclosed herein.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the seat assembly as shown in the various exemplary embodiments are illustrative only. Although only a few embodiments have been described in detail in this disclosure, those skilled in the art who review this disclosure will readily appreciate that many modifications are possible (e.g., variations in sizes, dimensions. structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications. changes and omissions may also be made in the design, operating conditions and arrangement of the various exemplary embodiments without departing from the scope of the present invention.

What is claimed is:

1. A pressure-distributing foam structure for use in a seat application, the foam structure produced from a foam mixture comprising:
an ethylene oxide capped diol in a range of about 37 to about 96% weight,
wherein the foam structure has a hardness at 25% deflection that varies within +/−150% in a temperature range of −20° C. to 50° C., and
wherein the foam structure has a hysteresis loss that varies within +/−40% in the temperature range of −20° C. to 50° C.

2. The pressure-distributing foam structure according to claim 1, wherein the ethylene oxide capped diol comprises an ethylene oxide capped di-functional polyether polyol.

3. The pressure-distributing foam structure according to claim 1, wherein the foam mixture further comprises at least one of:
a copolymer polyol in a range of less than 60% weight; and
a base polyol in a range of less than about 60% weight.

4. The pressure-distributing foam structure according to claim 3, wherein the base polyol comprises a polyether polyol.

5. The pressure-distributing foam structure according to claim 1, wherein the foam mixture further comprises one or more of water in a range of less than about 7% weight, a surfactant in a range of less than about 4% weight, and a cell opener in a range of less than about 20% weight.

6. The pressure-distributing foam structure according to claim 1, wherein the foam mixture further comprises a cross-linker in a range of less than about 5% weight, and wherein the cross-linker is one or more of triethanolamine, diethanolamine, and glycerine.

7. The pressure-distributing foam structure according to claim 1, wherein the foam structure has a hardness at 25% deflection that varies within +/−100% in the temperature range of −20° C. to 50° C.

8. The pressure-distributing foam structure according to claim 1, wherein the foam structure has a hysteresis loss that varies within +/−20% in the temperature range of −20° C. to 50° C.

9. A vehicle seat assembly comprising:
a seat component comprising:
a frame structure; and
a pressure-distributing foam structure according to claim 1,
wherein the foam structure abuts the frame structure.

10. The vehicle seat assembly according to claim 9, wherein the seat component is one of a seat cushion, a seat back, a head rest, an arm rest, or a combination thereof.

11. A method of making a pressure-distributing foam structure, comprising:
mixing an ethylene oxide capped diol in a range of about 37 to about 96% weight and at least one of a copolymer polyol in a range of less than 60% weight, and a base polyol in a range of less than about 60% weight;
disposing the foam mixture into a mold; and
curing the foam mixture to form the foam structure,
wherein the foam structure has a hardness at 25% deflection that varies within +/−150% in a temperature range of −20° C. to 50° C., and
wherein the foam structure has a hysteresis loss that varies within +/−40% in the temperature range of −20° C. to 50° C.

12. The method according to claim 11, further comprising removing the foam structure from the mold.

13. The method according to claim 11, further comprising installing the foam structure into a vehicle seat.

14. The method according to claim 11, wherein the mixing comprises mixing the ethylene oxide capped diol with two or more of the copolymer polyol, the base polyol, and a polymer additive in a range of less than 30% weight.
